(19) United States
(12) Patent Application Publication
(10) Pub. No.: US 2019/0347713 A1
(43) Pub. Date: Nov. 14, 2019

(54) AUCTION AND SALE METHOD AND SYSTEM

(71) Applicant: Gur COHEN, Rishon Lezion (IL)

(72) Inventor: Gur COHEN, Rishon Lezion (IL)

(21) Appl. No.: 16/478,506

(22) PCT Filed: Jan. 16, 2018
(86) PCT No.: PCT/IL2018/050059

§ 371 Date: Jul. 17, 2019

Related U.S. Application Data
(60) Provisional application No. 62/447,159, filed on Jan. 17, 2017.

(51) Int. Cl. G06Q 30/08

(52) U.S. Cl. CPC G06Q 30/08

(57) ABSTRACT

The new form of sales. Disclosed herein is an auction and sale system and method that provides a fast, efficient, and simple way users can purchase items and sellers can sell items. The system provides a maximum of two bids for any given item, thereby accelerating the process. The seller set three inputs into the system: maximum price, minimum price & period sell time or date and time will expire. Auction timer started with the first bid (or by the seller setting). If no other user provides a second bid, then the first buyer wins the item. If a second buyer places a bid for the item, then the second buyer wins the item at the current price and the sale is over. In addition, a monetary timer is implemented in which the timer decrements from the maximum price to the minimum price over monetary time units that is based on the gap between the minimum and maximum prices, and the time period set by the seller. As long as the low price is attractive to buyers, the sale will be quick and not necessarily at a low price, with a good chance of a second offer even by the first bidder.

### CROSS-REFERENCE TO RELATED APPLICATIONS

The present application claims the benefit of and priority to U.S. provisional patent application No. 62/447,159 filed on Jan. 17, 2017, the entire contents of which is hereby incorporated herein by reference.

### BACKGROUND

The present invention is in the field of services, sales, tenders (auctions) machinery. Sales in general and in particular in electronic media there are many types of sales as ordinary sales, promotions, auctions, coupons, consumer-to-consumer, business-to-consumer sales and business-to-business. There are many platforms and methods of services, sales and marketing. For a successful sale should have at least two sides, a seller and a buyer.

In every sale there is an asking price, a realistic price, a minimum price that is below the price the transaction of the transaction not paid off to the seller, and a period of time for the respective sale. Many common sale systems and methods use a system in which the sale is completed according to the current asking price or the highest bidder. Existing e-sales market apps and websites such as eBay®, Amazon®, and the like, also have radio and dedicated television program sales channels. These current systems at times can result in a negative purchase pressure effect and does not account for the buyer when the price goes up, and the customer has little if no control over the buying price.

### SUMMARY

The present disclosure provides a system for carrying out an auction for a variety of platforms such as reverse tender (auction) pricing (minimum price and maximum price fixed in advance) for a predetermined specified period of time, and the prices can vary depending on the category of the sale and the various choices of the seller. This method is designed to encourage and accelerate the sale of a product or service (e.g., new or second-hand) with maximum and minimum starting prices that are set by the seller.

For example, a seller may access a cloud-based auctioning service using his computing device, such as a personal computer (PC), mobile device, tablet, laptop, etc. Accessing the auctioning service, such as via a website associated with the auctioning service, the seller may elect to place an item up for sale for which buyers can bid or otherwise purchase. The seller may include various details about the item, such as its name, manufacturer, size, condition, and other details to inform prospective buyers of the item. In addition, the seller may input a predetermined set period of time (e.g., minutes, hours, weeks, days, etc.) for the item to stay on the market for bidders. The auction system further require the seller to input a maximum amount that buyers can bid for the item and a minimum amount that buyers can bid for the item.

After the seller inputs the information, the item may be made available to buyers via the auctioning service's website or other application that is associated with the auctioning service. A first buyer can elect to bid on the item anywhere from and including the minimum and maximum asking prices chosen by the seller. After the first buyer places a bid at the minimum price, then the Auction timer start fall down from the maximum price to the minimum at the period time the seller sets, another buyer (i.e., a second buyer) can place a bid and thereby win the item, meaning second bid always, win even if it's by the first bidder. Alternatively, if no second bid then first bid over the course of the predetermined time period, wins the item.

The auctioning service is configured for no more than two participants. That is, although multiple users may be able to see the bidding on items, after the second bid the sale for that particular item is officially complete and thereby completed.

The present invention takes various data from the seller, refines the data, and actually gives a platform to simplify, focus and make a fair and quick sale. The present invention provides a method of reverse auction, targeted, fast and efficient marketing and sales. The invention solves the needs for less popular products and not just, which require the promotion, marketing and speeding up the sale and of course popular products.

The invention's method allows businesses, traders and private individuals to sell their goods in a fair, and efficient manner with full transparency. Unlike other methods sale and auctions current practices, the proposed maximum starting price falls down to the minimum price proposed and the time is the trigger that determines the price of a product to that point in limited period time.

The current invention's method of sale purchase has a positive effect, when all information is known and visible, making it fair and transparent, after the auction opened money timer go down from the maximum price and the purchase price controls (physical or applicative button), and the first to bid win in the lowest price the tender if there is no second bid. If there is second bid then second bid always wins.

The present auction and sales system and method is advantageous because it provides a time period for each individual sale based on the seller's input, while also taking into consideration the minimum and maximum prices. Thus, whereas alternative systems may have a stagnant time period regardless of the selected prices, the current system is able to take into consideration the prices of the item for sale as well. The present auctioning system seeks to save system memory by reducing the amount of time that less desirable items are stored on a server, while also reducing the amount of battery power for various user devices and the server to host the item to continuously place the item up for sale. Furthermore, unnecessary bandwidth is saved by only requiring a maximum of two bids for a particular item, as opposed to a series of incremental bids that buyers make when a timer is about to expire. In the current system, because the second bidder will win the item, this will accelerate the overall process and bidding war among buyers, which, as stated above, saves various system resources including system bandwidth, network bandwidth, system battery power, and system memory.

### BRIEF DESCRIPTION OF THE DRAWINGS

Further clarification to the invention can be illustrated with an accompanying illustration. Although illustration is intended to illustrate examples in which the system and method, procedure execution organization and method of the invention operating part of the invention, together with its advantages, may be understood by reference to illustrations and descriptions. The illustrations are not intended to reduce the scope of this invention, but only to clarify the invention. For a more complete understanding of the present invention, reference is now made to the following figures in which:

FIG. 1. Shows a diagram of the embodiment of networks and multiple connections of users to manage the sale or buying, the user logs on using a representative, phone, terminal or traditional auctions with a dedicated button for each participant (PC, Smartphones, tablet, SmarTV, laptop, smart watch, sales and service representative etc.). The complexity of the system and the present invention enables connections to enter, process, view data and choose among the options menu.

FIG. 2. Flow chart of the process of connecting the user system.

FIG. 3. Process flow chart of Advertising of Sales\Auction\tender with the complexity the many possibilities embodied in it.

FIG. 4. The process flow chart of the user expects sales posted in and choose among the options offered.

FIG. 5. Flow chart of search process, offer, purchase, and payment in the case of winning or search from the case of non-winning.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention.

The present invention is an auction method that mediates between business to consumer (B2C), business to business (B2B), and consumer to consumer (C2C).

For the present auctioning system and method, a seller has three pieces of data to determine and input into the system, a period of time for the sale (or alternatively date and time for the sale to expire), a maximum price for the sale, and a minimum price for the sale. In addition, the seller can enter various information about the product, including make, model, manufacturer, condition of the item, etc.

If the low price is attractive enough for a first customer (or bidder), the first customer who wants the item may click the a button on a user interface of their computing device, which thereby make a bit on the minimum price and at the same time opens the auction and triggers a timer for the monetary amount to start to fall below the maximum price to the minimum in the same period of time determined by the seller. The present method perfects a time period divided by the difference between the maximum and the minimum prices and divides into small units that decrease and thus generate a financial timer.
The formula:

$$\frac{x - n}{t} = u$$

Finance(money) Timer clock: x−u (every second)
Timer stopped at n or next click(bid))
x=maximum price
n=minimum price
t=time
u=units time

### EXAMPLE

x=3750 n=2406 t=60(sec) then the result of that is u=0.0224
The timer is start at 3750-0.0224 repeat every second (in this example) until it go down until it get to 2406 and stopped after 60 seconds or stopped if someone click the button to stopped it(second bid) at the current number (price)

The tender is intended for a maximum of two active participants. After the auction started with the first bid if no further input for bidding occurs, the price will be reduced to a minimum and the first customer that bid will win the product at the minimum price unless there's second bid then the bidder win at price it's stopped. In other words, the second clicking (bid) always wins.
The above does not detract from the first bidder being the second bidder and to win the sale.
Alternatively, if the auction timer started by the seller or by the system, and there is no bid by customer then the timer will get down to the minimum price, stopped and the sale auction will fall down.
In this case there can be only one proposal and is the winning bid.

The seller set the opening price initial tender and the final price decides and time limit stipulated by the system or by the seller. The secret of the successful sale depends on a combination of correct pricing of the high and low price and time of the sale.

The gap between the higher to the lowest price calculated with the period time to get cost by the second, minute, hour, day, etc. When the auction starts (i.e., after the first customer bid), time reversal of money timer from the maximum price to the minimum price occurs. Specifically, the structure of time based on the timer calculates the gap between the maximum and minimum price the divided by time and the financial timer produces the small monetary units.

$$\frac{Gap price}{time} = unites time ↔ money timer max price - units time every sec$$

As long as the low minimum price is attractive, not only will the sale process take place faster, so will many potential customers be more interested, and therefore the probability that the sales timer will stop at a higher price.

Traditional auctions can use the system with a button for each main screen user or any user and system that processes the data and displays on the screen.

There are other configurations for the auction system:

Basic Tender and flexible Tender which it also has more options. Basic Tender have few alternative, first alternative bases and a major auction. There is a maximum of two tender offers (maximum two participants). The first offering begins the auction, and win the auction at the minimum price if there is no other offers. And in case that there is second offer, then second offer is sure winning and ends the auction.

That is if you don't have any bid, Tender will not start and after a fixed period of time the auction falls, the seller will need to open a new tender more attractive.

Second alternative basic tender which maximum one participant offer, meaning the first bidder wins!

Seller or system is start the auction and price goes down to the minimum price if there is no proposal falls auction closed after period of time.

Another configuration is flexible tender comes with a variety of flexible options for the seller and/or the buyer. The first alternative basic and major works tender. The product for sale at a minimum realization of sale. The first proposal to buy the tender is launched.

Mask sale that hides the minimum price from the clients.

Businesses will be able to allow a single winning Group Limited quantity for sale, provided that Buyer more lowers the per unit price for each participant so that everyone actually get more discounted price and seller selling additional quantity will be limited in quantity and in time to join.

Bulk auction sales for more than one service, tickets or products.

### Example 1

Apartment for sale priced at market around 890 k, owner asking 910K, the last bargain price is 860K, owner publishes his apartment maximum 940 k starting price, and 860K final price, and set 80 days period for the tender, 1 k goes down every day, i.e. time unit is: 1 hour=41.667; 1 Minute=0.694; 1 second=0.011, the First bid open the tender (if not bid after period of time, tender drop down & closed), the first bid for the apartment on 860 k is ON (if no other bid the bidder win the apartment), after the first bid money timer star go down, 24 days after the tender is on 886K get Second bid & second bid always win.

### Example 2

Group sales of 5 new cars from the agency, retail price 38K, sale price 36K, agency post a tender with 38 k maximum price 32 k minimum price and 7 days period, 857.142 goes down every day, i.e. time unit is: 1 hour=35.714; 1 Minute=0.596 ; 1 second=0.009, 96 hours after tender started, bid winner on price 34.456 k, the agency can decide to open the sale to group sale for limited time to 3 more sales, every other bid put down the winner price in 1 unit price (in this case 1 hour) 35.714 that is if 3 other join to the win price the price for all get down with 3 unit then the price for all 4 winner will be 34.464 k, the seller decide if & for how many group bids it open.

Usually when the price is really attractive first offering will not sit and wait until the end of the auction and will submit another proposal to ensure the winning

The second alternative tender Basic is when the seller like the previous tender sets a maximum price and minimum price and determines the length of time the tender and unlike the previous auction seller actually decide when to open the auction and once the tender opening price is the highest price declining by time and pace determined when actually this auction can be just one bid and this first bid win.

In flexible tender, the user can bid any price within predefined amount, and the seller can immediately allow the transaction without having to wait for a second offer or the end of the period.

Flexible tender buyer and seller also can change or speed up the time or the price as the tender For example, first to make an offer higher than the minimum.

After the tender was opened, can buy one unit of time at half the cost to expedite the time, for example if the time unit=2 k can short the tender in a unit on half cost of the time unit to 1 k, but that does not guarantee the sale if someone bid before, and the cost of the expedite will not be returned catalyzes the auction.

Seller can speed up once every 2 units of time, i.e. you cannot make expedite time after time. Another option to expedite tender is to buy time units at cost of 75% and get the price directly to the target price for him initial purchase for unit of time if no proposed acquisition time allotted auction continues from that point to go down and then the price will continue to falls straight to propose purchase.

Even in this case acceleration payment won't return payer and go straight to the seller\system no matter what the status of the final sale.

All these are just a few examples do not require options that can be done and can be changed as needed.

As required, grossing a detailed illustration of the present invention are disclosed herein. However, techniques, systems, and operating structures in accordance with the present invention may be illustrated in a variety of forms and situations, some of which may be quite different from those locations, illustrated here. As a result, the structural and functional details specific disclosure herein represent only still on this matter, they are considered best illustrate the purposes of disclosure, which defines the scope of the present invention. The following table details the preferred embodiment of the detail as well as an alternate embodiment, such as simple or complex illustration for the method of the present invention.

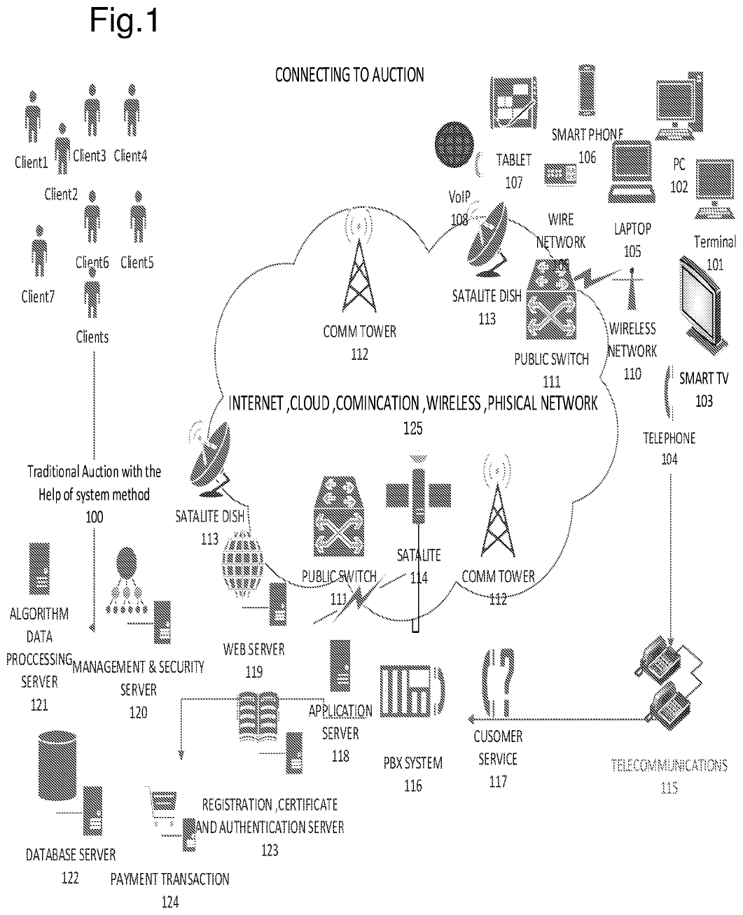

Referring to FIG. 1, this is a diagram of an embodiment of a networked system connecting a plurality of users to perform a host of tender the present invention method of users and advertisers. Users can use the system by traditional auction 100 with physical buttons to interactive the system also the access through Terminal hosts, multiple devices, which may include, for example, 102 PCs, 101 workstations, 105 laptops, 103 smart TVs, smart watch and smartphones 106, 107 tablets, smart watches, representatives of utilities, telephones and so on. To the user connection devices can communicate with a server hosting a number of ways. In the embodiment advantage of the present invention, connection devices the user to communicate with the server host 119 application server 118 via the Internet with the help of using a means of access wireless 110, or lines routers\dials 109 through routers involved in public 111 that connect wirelessly to 112, a wired or optical or using satellites 113,114 and 117 telephone customer service with PBX phones 104 and 115 over the Internet using VoIP PBX 116 via data, voice, and/or through public switching involved 125. 118 application server and Web server 119 that receive the requests of users and advertisers log in search advertising and submission of tenders\sales. As part of the system management server requires timidly DATABASE 122 to store all the information in an encrypted financial transaction server 124 for managing the financial system. Server registration, management and authentication 123 which allows management and control system users. Server security management and protection systems 120 on each registration, payments and invitations to tender and is responsible for tracking and monitoring. 121 algorithm server which processes sales data and refine them to the timing of the sale, computer timer back the amount of money difference unit smaller part of the time and the timer back monetary units or units time and time displays database and application scheduling it for sale. In addition to managing telephone sales with keypad or voice 115\Chat 125\116 VOIP or directly with a human\auto representative.

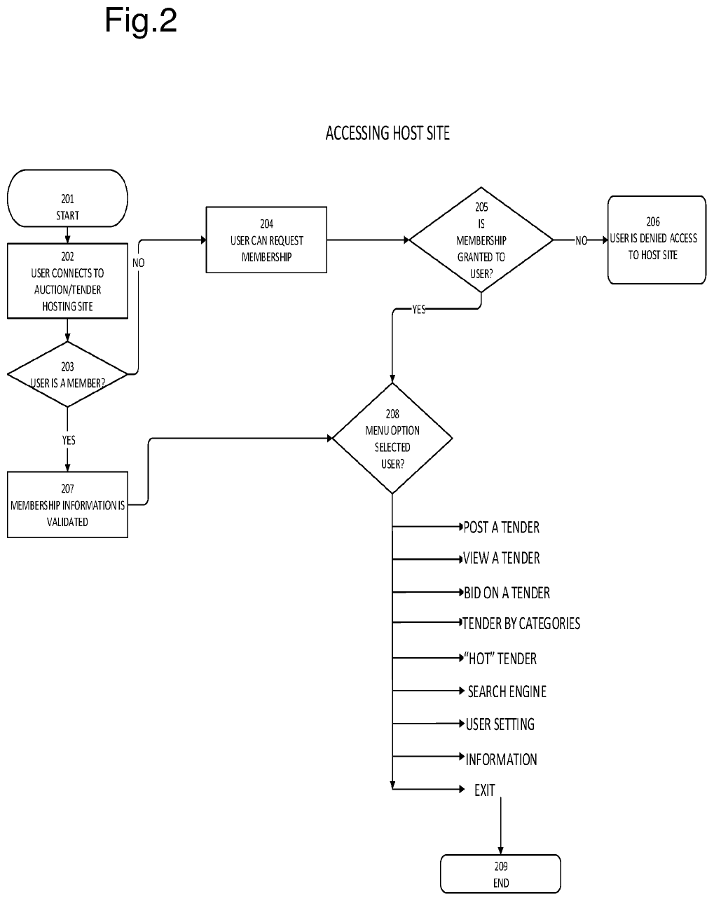

Referring to FIG. 2, this is the connection to the host system. The user connects to publish or participate in the auction or sale 202. Is a registered user in 203 unless he submits a request to membership 204 if the application is rejected 206 or accepted 208, presented a menu of options, even if the user is registered in the system connects 208 and get the options menu.

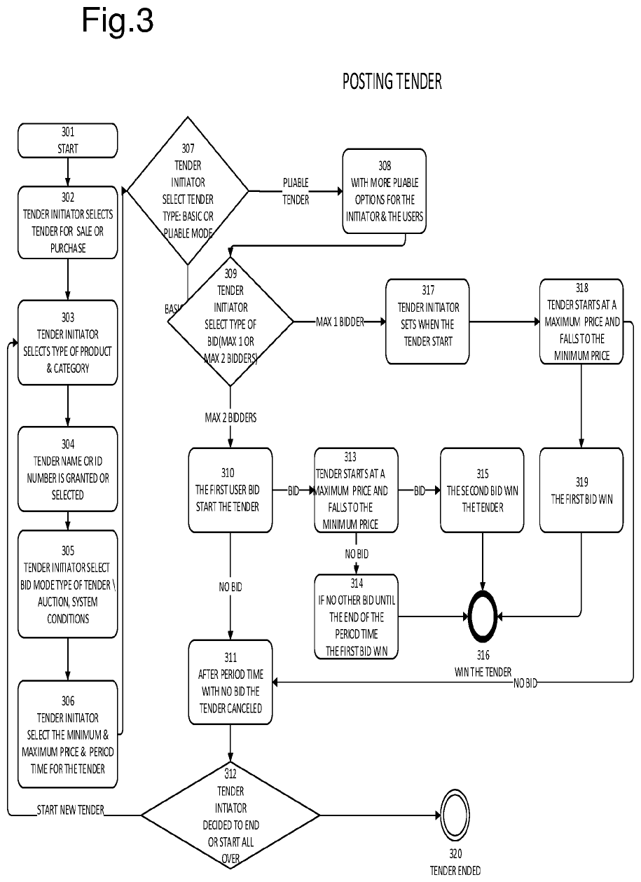

Referring to FIG. 3, this is the process of posting Sales\tender. Advertises the sale chooses a tender to sell or buy 302, then choose a category and product type 303, the product gets there\unique number 304. Publish the tender choose what kind of selling is interested in 305, publishes tender stipulates a minimum price and a maximum product and choose the time of sale or interval determined by the auction system or the seller 306. Initiator selects the type of basic or flexible tender\auction 307. In the case of flexible tender is based on the basic auction with additional options and variable set by the seller 308. In the case of a basic Tender\Auction 309 comes in two options: one at a maximum of two bids the first bid start the tender 310. And if there is no any bid the tender is canceled 311 and then tender initiator decide whether to terminate the sale 320 or try to publish again 312 and begin the process again 303. In case that was first bid it actually open the sales and the Tender starts from maximum price to the minimum price with period of time 313 if there is no second bid until the end of the tender time then the first bid win the tender at the minimum Price 314, in the case that has second bid then this bid winning the Tender at actual price 315. The second option has one bid and basically the seller determines when the auction opens 317. The tender was opened at maximum and decreases to a minimum if by the end of the period of time no bid 311 Auction is canceled and there bidder can end the auction 320 or renew 303. If there is bid in period of time is actually Tender winner 319.

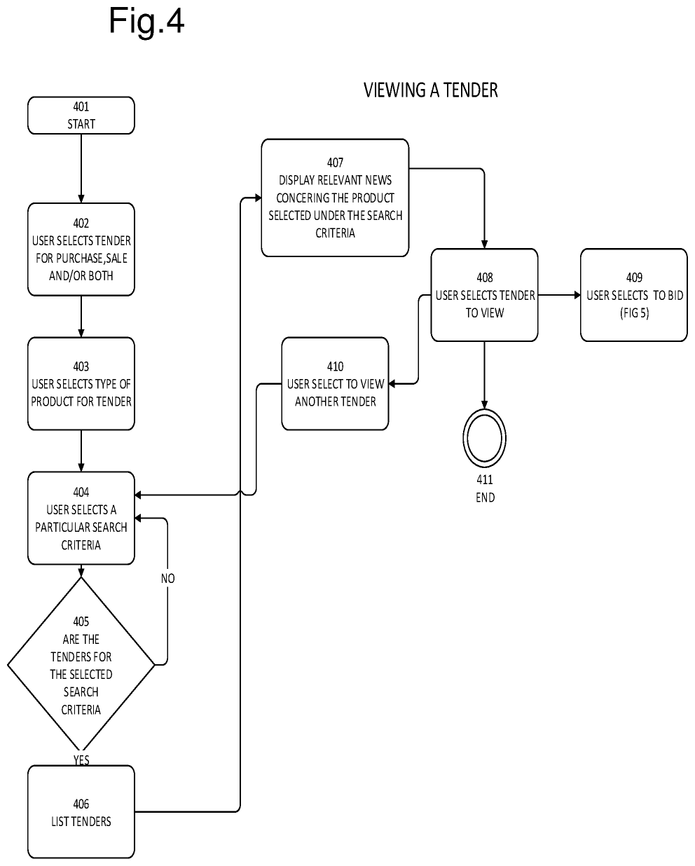

Referring to FIG. 4, this to show viewing tender. A user can select sale or tender or auction to bid 402. The user selects which type of product is interested 403 searching a specific criteria 404. If the user not found a product he can go back and search again if he found he get a list of sales\auctions 406. Under the selected category 407 Results user selects the relevant tender 408 user choose whether to submit a proposal 409 or to end the search 411 or search again 410.

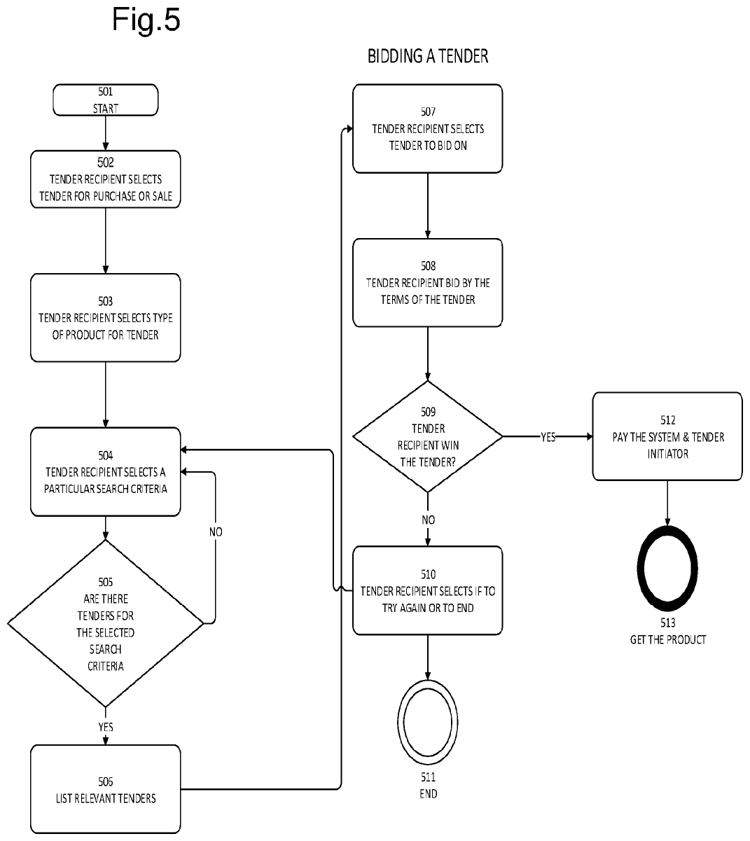

Referring to FIG. 5, this is to show the process of bidding a Tender. The bidder chooses a Tender to purchase or sell 502 then selects the type of product auction 503 offers tender makes specific search 504 if there are no results in this category returning to search again, if there are results 505 then get a list of results 506 bidder chooses to tender to submit its proposal 507 submits a proposal in accordance with 508 auction conditions if the bidder wins the auction pays the seller 512, and receive the product 513 if the bidder does not get 510 and then choose whether to try again at 504 or to end the bid 511.

The present auction and sale system and method can be performed using a variety of computing devices over a network.

FIG. 1 includes example systems in which the features described above may be implemented. It should not be considered as limiting the scope of the disclosure or usefulness of the features described herein. In this example, the system can include various servers and computing devices. The servers and computing devices can contain one or more processors, memory and other components typically present in computing devices.

The one or more processors can be any conventional processor, such as a commercially available Central Processing Unit (“CPU”). Alternatively, processor can be a dedicated component such as an Application-Specific Integrated Circuit (“ASIC”) or other hardware-based processor. Although not necessary, the server may include specialized hardware components to perform specific computing processes, such as decoding video, matching image frames with images, distorting videos, etc. faster or more efficiently.

The memory can include data that can be retrieved, manipulated or stored by the one or more processors. The memory can be of any non-transitory type capable of storing information accessible by the one or more processors, such as a hard-drive, memory card, Read Only Memory (“ROM”), Random Access Memory (“RAM”), Digital Versatile Disc (“DVD”), Compact Disc Read-Only Memory (“CD-ROM”), and write-capable memories.

The instructions can be any set of instructions to be executed directly, such as machine code, or indirectly, such as scripts, by one or more processors. In that regard, the terms “instructions,” “application,” “steps” and “programs” can be used interchangeably herein. Instructions can be stored in object code format for direct processing by the one or more processors, or in any other computing device language including scripts or collections of independent source code modules that are interpreted on demand or compiled in advance. As an example, the instructions may include instructions to authenticate users, create and terminate sessions, and transmit electronic notes, as discussed in further detail below. Other functions, methods and routines of the instructions are explained in more detail below.

The data can be retrieved, stored or modified by the one or more processors in accordance with the instructions. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, American Standard Code for Information Interchange (“ASCII”) or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

Referring to FIGS. 1 and 2, the server may communicate over a network in order to communicate with a database. In this regard, although FIG. 1 illustrates data and database being accessible by the server over the network, it should be understood that the database may alternatively be stored within data of server. Alternatively or as another example, the data and the database may be connected to the server via a physical connection or wireless connection such as via Wi-Fi. In this regard, the network depicted in FIGS. 1 and 2 may be considered a Personal Area Network (“PAN”), Local Area Network (“LAN”), Wide Area Network (“WAN”), the Internet, etc.

Thus, the one or more processors, memory, server, displays, etc. can actually comprise multiple processors, memories, servers, displays, etc. that may or may not be stored within the same physical housing. For example, the memory can be a hard drive or other storage media located in a housing different from that of server. Accordingly, references to a processor, memory, computer, server, etc. will be understood to include references to a collection of processors, memories, computers, servers, etc. that may or may not operate in parallel. For example, the server may include a single server computing device or a load-balanced server farm. And although some functions described below are indicated as taking place on a single computing device having a single processor, various aspects of the subject matter described herein can be implemented by a plurality of computing devices, for example, communicating information over the network.

For instance, data may include database to store various information, which server may communicate with over the network. Information stored in database includes user account information such as user identity, company each user is associated with, usernames, and authentication information. Database may further store company information, which may include at least user data, session data, electronic notes, session expiration data, and channels that have been established. Server can have the capability to read, write, and access data on database. Furthermore, database, server, or both may operate using expandable cloud storage capabilities, such as a proprietary system.

Furthermore, server may include multiple servers operating together. Thus, although the disclosure herein may refer to server, it should be understood that specially programmed and dedicated servers may be performing certain tasks.

Server can include display (e.g., a monitor having a screen, a touchscreen, a projector, a television, or other device that is operable to display information), and user input. The user input may include, for example, a keyboard, touchscreen, and mouse. Other input devices are also possible, such as a microphone. In this regard, the server may include only one or a plurality of the various input devices. The server may also include various modules and partitions that are stored in memory and accessible by the one or more processors to perform certain functions as described in more detail below.

Computing device may also include one or more processors, memory, instructions, data, instructions, display, and user input, all of which may perform similarly as discussed above with respect to the one or more processors, memory, instructions, data, user input, and display of the server. Furthermore, although not shown client computing device may also include input devices such as a keyboard, touchscreen, a mouse, or any combination thereof. In addition, as illustrated in FIG. 1 client computing device includes camera as an input device. In addition, client computing device may also include a Global Positioning System (“GPS”) device or other geo-location identifying systems in order to identify the location of computing device. For example, the positioning component may include a GPS receiver to determine the particular device's latitude, longitude and/or altitude position. The location of the client computing devices may include an absolute geographical location, such as latitude, longitude, and altitude as well as relative location information, such as relative to a particular device or object. Although not shown, client computing devices may also include one or more processors, memory, a display, various input devices, GPS etc. and overall may be constructed and configured to operate similarly to client computing device as discussed above.

Similarly, processor and memory of client computing device may be contained within the same housing or operate remotely from each other, and may include a plurality of components therein. For instance, processor, memory, and other components of client computing device may be a plurality of processors, memories, etc., and should not be restricted to a single or particular type of processor or memory. Further, information collected on client computing device may store temporarily in memory (such as in Random Access Memory or on an internal hard drive) and be transmitted over network to a remote database (not shown) in a hard drive, or alternatively transmitted to server and then to database. The client computing device are also configured similarly to client computing device.

Client computing devices may each comprise any type of computing devices. For instance, the client computing devices may comprise a personal computing device or a mobile computing device capable of wirelessly exchanging data with each other or server, such as via network. FIG. 2 illustrates exemplary computing devices of server and client computing devices. By way of example only, client computing devices may be a mobile phone (e.g., Smartphone) or a device such as a wireless-enabled PDA, a tablet, a laptop, head-mountable device, Smart watch, or a netbook that is capable of obtaining and transmitting information via the Internet.

Server and client computing devices can be at nodes of network and capable of directly and indirectly communicating with other nodes of network. Although only a few computing devices are depicted in FIGS. 1-2, it should be appreciated that a typical system can include a large number of connected computing devices, with each different computing device being at a different node of the network. The network and intervening nodes described herein can be interconnected using various protocols and systems, such that the network can be part of the Internet, World Wide Web, specific intranets, Wide Area Networks, or Local Area Networks. Network can utilize standard communications protocols, such as Ethernet, Wi-Fi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

1. An efficient method of auctioning for maximum two bidders comprising:
a processing system operatively coupled with one or more memory systems, wherein the memory stores instructions which, when executed by the one or more processors, cause:
receiving sale data from a seller including description of a product, minimum and maximum price for an item and time period of the auction;
receiving the type of auction from the seller, wherein, seller selecting the type of auction corresponding to basic or flexible;
calculating a monetary timer using maximum and minimum prices for the item and the designated time period provided by the seller;
upon receiving a first bid from a first buyer, starting the timer for bidding;
upon receiving a second bid, ending the bidding and timer such that the second bidder wins the item and when a second bid is not received for the item, award the item to the first buyer;
wherein, maximum number of bidders cannot exceed two to save various system resources including system bandwidth, network bandwidth, system batters power, system memory and the like.

2. (canceled)

3. The method of claim 1, wherein the monetary timer is calculated using a determined gap between the minimum price and the maximum price, and dividing the designated time period into the determined gap, such that the monetary timer is broken down into monetary units that decreases as time passes.

4-5. (canceled)

6. The system of claim 1, wherein the maximum amount of bids for the item is two, and the second bidder wins the item.

7. A computing device to execute an auction process) comprising:
a user interface running on the computing device to receive sale data from seller and offers from buyers;
one or more processors operatively coupled with one or more memory systems, wherein the memory stores instructions which, when executed by the one or more processors causes:
receiving sale data from the seller including description of a product, minimum and maximum price for the item and time period of the auction.
receiving the type of auction from a seller, wherein, seller selecting the type of auction corresponding to basic or flexible;
calculating a monetary timer using maximum and minimum prices for the item and the designated lime period provided by the seller;
upon receiving a first bid from a first buyer, starting the timer for bidding;
upon receiving a second bid, ending the bidding and timer such that the second bidder wins the item and when a second bid is not received for the item, award the item to the first buyer;
wherein, maximum number of bidders cannot exceed two to save various system resources including system bandwidth, network bandwidth, system battery power, system memory and the like.

8. The method of claim 7, wherein the price of item may start to decrement after receiving the first offer or the price may start to increment after receiving the first offer or the price may not at all change after the first offer depending upon the type of auction selected by the seller.

9. The method of claim 7, wherein the monetary timer is calculated using a determined gap between the minimum price and the maximum price, and dividing the designated time period into the determined gap, such that the monetary timer is broken down into monetary units that decreases as time passes.

10. The method of claim 1, wherein basic Auction type comprises the start of bidding process with first offer and second offer winning the bidding. In case no second offer is received, the first offer winning the bidding.

11. The method of claim 1, wherein Flexible Auction type comes with a variety of flexible options for the seller and/or the buyer.

12. The method of claim 1, wherein monetary timer is implemented when timer decrements from the maximum price to the minimum price over monetary lime units and Auction timer started with the first bid or by the seller setting;

13. The method of claim 1, wherein the seller may input a predetermined set period of time by minutes, hours, weeks or days for the item to stay on the market for bidders;
